(19) United States
(12) Patent Application Publication
(10) Pub. No.: US 2018/0013219 A1
(43) Pub. Date: Jan. 11, 2018

(54) MATABLE ELECTRICAL INTERCONNECTION STRUCTURE AND ELECTRICAL DEVICE HAVING THE SAME

(71) Applicant: Unid Co., Ltd., Seoul (KR)

(72) Inventors: Chong Kwang YOON, Sujeong-gu, Seongnam-si (KR); Young Soo KIM, Jungwon-gu, Seongnam-si (KR); Yeong Uk SEO, Bundang-gu, Seongnam-si (KR); Yeong Joo MOON, Jungwon-gu, Seongnam-si (KR)

(21) Appl. No.: 15/545,698

(22) PCT Filed: Mar. 20, 2015
(86) PCT No.: PCT/KR2015/002748

§ 371 Date: Jul. 23, 2017

(30) Foreign Application Priority Data
Jan. 22, 2015 (KR) 10-2015-0010481

(51) Int. Cl. H01R 12/73; H01R 13/11; H01R 12/58

(52) U.S. Cl. CPC H01R 12/73; H01R 12/58; H01R 13/113

(57) ABSTRACT

Provided is a matable electrical connection structure including a female connection member and a male connection member respectively including a plurality of first connection portions and a plurality of second connection portions, and a plurality of matable connection portions configured to detachably couple the female connection member and the male connection member, and respectively and electrically connect the plurality of first connection portions to the plurality of second connection portions, and the matable connection portions include inner conductive materials respectively and electrically connected to the plurality of first connection portions and provided on inner walls of a plurality of insertion holes formed in the female connection member, columns respectively and electrically connected to the plurality of second connection portions and configured to protrude from the male connection member to be inserted into the insertion hole, and elastic fins configured to extend outside the column to elastically contact the inner conductive material, and at least one of the female connection member and the male connection member is divided into a plurality of areas, and the plurality of matable connection portions are disposed to form a group in each of the areas.

### TECHNICAL FIELD

The present invention relates to a matable electrical connection structure for electrical connecting between inside and outside portions of printed circuit boards, interposers, electronic packages, and connectors or for mutual electrical connecting thereof.

### BACKGROUND ART

An electrical connection structure is required to connect a printed circuit board (PCB) and devices (for example, semiconductor packages, passive devices, active devices, display modules, and batteries) mounted thereon, or to connect PCBs with other PCBs.

All electrical connection structures for mutual connecting between electronic devices in electrical circuits are mainly classified into two types including a solder bonding type and a socket type.

An electrical connection structure having a dual inline package (DIP) as the solder bonding type is most generally used, and FIGS. 8 and 9 illustrate examplary embodiments in which the electrical connection structure of the DIP type is mounted on a PCB.

As illustrated in FIG. 8, the electrical connection structure of the DIP type is disposed so that a plurality of pin terminals 20 in each component A to F (for example, connectors, and chips) face each other in 2 rows, and each of the pin terminals 20 is extended outside the components A to F, is soldered on a circuit board 10, so that the components A to F are surface mounted thereon.

FIG. 9 illustrates a drawing in which component A and component B among the components illustrated in FIG. 1 are viewed from a front thereof, and from this, it is recognized that a more than a certain distance d between solder portions 30 of the components A to F is required to avoid contact between the solder portions 30 of the components. Since this causes an area occupied by an electrical connection structure in a printed circuit board 10 to be increased, high density integration and the freedom of design of the printed circuit board 10 are inhibited.

In the case of the socket type, even though it is used when a number of input and output terminals are required and a matable type is essential, there is a problem in that an electrical connection between a female connector and a male connector can be disconnected by an external shock.

### DISCLOSURE

### Technical Problem

The present invention is directed to providing a matable electrical connection structure capable of implementing a fine pitch and small area, and stably maintaining an electrical connection and mechanical reliability.

The scope of the present invention is not limited to the above-described objects, and other unmentioned objects may be clearly understood by those skilled in the art from the following description.

### Technical Solution

One aspect of the present invention provides a matable electrical connection structure including a female connection member and a male connection member respectively including a plurality of first connection portions and a plurality of second connection portions, and a plurality of matable connection portions configured to detachably couple the female connection member and the male connection member, and to respectively and electrically connect the plurality of first connection portions and the plurality second connection portions, and the matable connection portions include inner conductive materials respectively and electrically connected to the plurality of first connection portions and provided on inner walls of a plurality of insertion holes formed in the female connection member, columns respectively and electrically connected to the plurality of second connection portions and configured to protrude from the male connection member to be inserted into the insertion hole, and elastic fins configured to extend toward an outside the column to elastically contact the inner conductive material, and at least one of the female connection member and the male connection member is divided into a plurality of areas, and the plurality of matable connection portions are disposed to form a group in each of the areas. According to the matable electrical connection structure of the present invention, the elastic fin is bent in a direction opposite to an insertion direction of the column when the column is inserted.

According to the matable electrical connection structure of the present invention, the plurality of areas are divided according to a type or function of a component connected to the first connection portion or the second connection portion.

According to the matable electrical connection structure of the present invention, the plurality of areas in an array shape are disposed adjacent to each other. In this case, the plurality of areas are combined to form a two dimensional array shape.

According to the matable electrical connection structure of the present invention, each of the plurality of areas has the same size or has a different size.

According to the matable electrical connection structure of the present invention, the plurality of matable connection portions are disposed in an array shape in each of the areas.

According to the matable electrical connection structure of the present invention, a soldering area of the first connection portion or the second connection portion and a printed circuit board is disposed in each of the areas.

According to the matable electrical connection structure of the present invention, the female connection member or the male connection member includes at least one of an active device, a passive device, a connector for electrical connection, a semiconductor chip package, an interposer applied to a semiconductor package, a semiconductor chip and package having a three dimensional multilayered structure, and a multilayered ceramic capacitor.

### Advantageous Effects

According to an exemplary embodiment of the present invention, a mounting area occupied by an electrical connection structure can be decreased because at least one of a female connection member and a male connection member is divided into a plurality of areas, and a plurality of matable connection portions are disposed to form a group in an array shape in each of the areas.

In other words, there are effects in that many of the electrical connection structures can be disposed in a small space, and a fine pitch between connection structures can be implemented because of the electrical connection structure described above.

In addition, there are advantages in that disassembling and reassembling are possible, and mechanical reliability and impact resistance of an electronic component assembly is high because of a structure of a matable connection portion using an elastic fin structure.

In addition, there are advantages in that an electrical signal speed can be increased by implementing the electrical connection structure in a low height and nearly linear structure, and a signal quality can be increased by reducing a signal loss.

### DESCRIPTION OF DRAWINGS

FIG. 1 is a plan view illustrating an examplary embodiment of a printed circuit board in which a matable electrical connection structure according to the present invention is applied.

FIG. 2 is an enlarged view of the matable electrical connection structure in FIG. 1.

FIG. 3 is a view illustrating a modification of the matable electrical connection structure in FIG. 2.

FIG. 4 is a schematic view illustrating an area arrangement shape of a matable electrical connection structure of the present invention.

FIGS. 5 and 6 are cross-sectional views illustrating a matable electrical connection structure according to an examplary embodiment of the present invention.

FIG. 7 is a plan view illustrating a column and elastic fins illustrated in FIGS. 5 and 6.

FIGS. 8 and 9 respectively are a plan view and a front view illustrating a printed circuit board in which an electrical connection structure having a dual inline package type is applied.

### MODES OF THE INVENTION

An electrical connection structure disclosed in the present invention is a concept which covers all structures for electrical connecting between printed circuit boards applied to all types of electronic devices such as all types of mobile phones, display devices and the like, and electronic devices mounted on the printed circuit board, and a printed circuit board and electrical components. The electrical connection structure is capable of being applied to electronic devices such as all types of mobile phone, and display devices, and in this case, an electrical connection structure of the present invention may be provided in a housing configured to form an appearance of an electronic device. One examplary embodiment of this may be an electrical connection structure between a printed circuit board installed in a housing and electronic components mounted thereon.

Hereinafter, a matable electrical connection structure related to the present invention will be described in detail with reference to accompanying drawings.

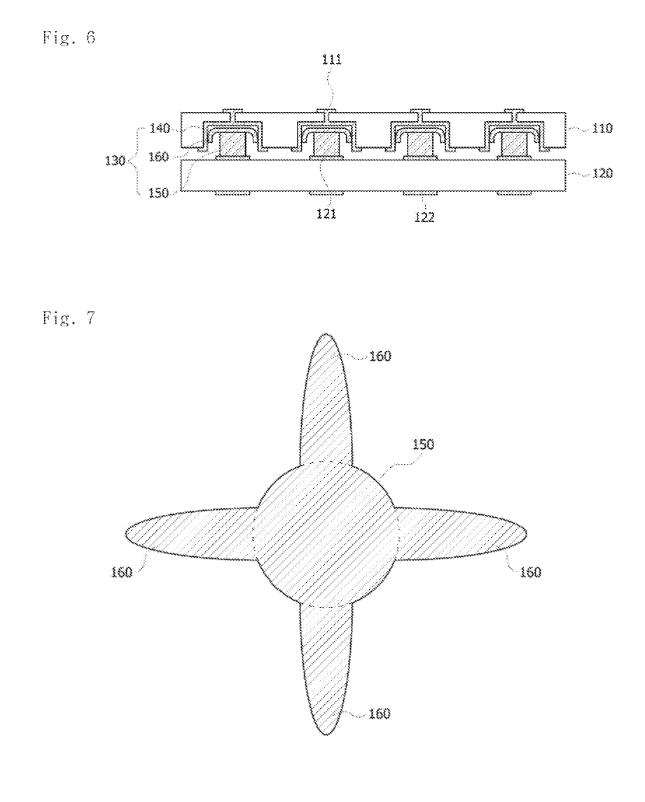

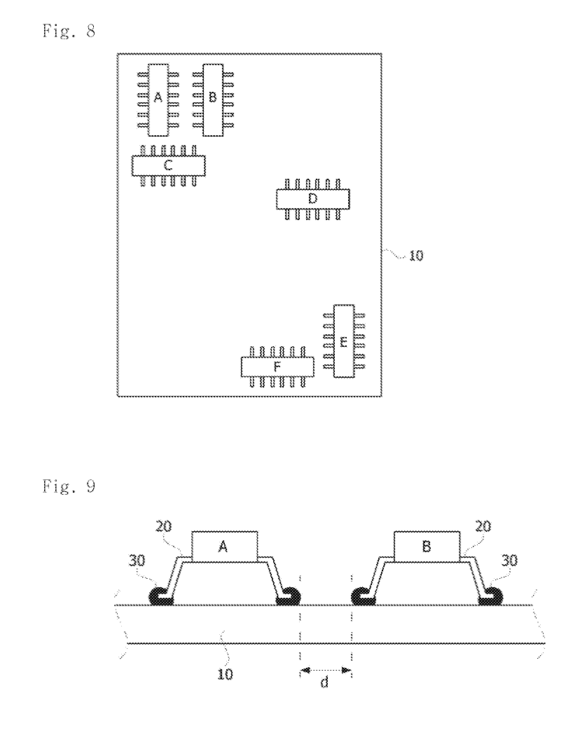

FIGS. 5 and 6 are cross-sectional views illustrating a matable electrical connection structure according to an examplary embodiment of the present invention.

As illustrated in FIGS. 5 and 6, a matable electrical connection structure according to an examplary embodiment of the present invention includes a female connection member 110, a male connection member 120, and matable connection portions 130.

The female connection member 110 and the male connection member 120 are a male and female structure configured to electrically and physically connect between printed circuit boards or components mounted on a printed circuit board. FIG. 5 illustrates a state in which the female connection member 110 and the male connection member 120 are separated from each other, and FIG. 6 illustrates a state in which the female connection member 110 and the male connection member 120 are coupled.

The female connection member 110 and the male connection member 120 are objects to be coupled by the male and female structure described below, and may be formed in the printed circuit board or may be a stand-alone component configured to be mounted on a printed circuit board. For example, the female connection member 110 or the male connection member 120 may include at least one of an active device, a passive device, a connector, an interposer applied to a semiconductor package, a semiconductor chip package, a semiconductor chip and package having a three dimensional multilayered structure, and a multilayered ceramic capacitor.

The female connection member 110 and the male connection member 120 may be formed of an insulating material, or a combination of an insulating material and a conductive material. A raw material of the female connection member 110 and the male connection member 120 may be one or a combination of more than one of a ceramic, a polymer, silicon, glass, a metal and the like.

The female connection member 110 and the male connection member 120 respectively include a first connection portion and a second connection portion. The first connection portion and the second connection portion refer to objects configured to be electrically connected by a connection between the female connection member 110 and the male connection member 120, and examples thereof may include pads, circuit patterns, bumps, solder balls, via holes and the like. According to an examplary embodiment of the present invention, a pad 111 formed on upper surface of the female connection member 110 is provided as one example of the first connection portion, and a pad 122 formed on a lower surface of the male connection member 120 is provided as one example of the second connection portion. For reference, the pad 122 of the lower surface of the male connection member 120 is capable of being electrically connected through a conductive structure such as a pad 121 of an upper surface of the male connection member 120 and a via hole. The plurality of first connection portions are provided at the female connection member 110, and the plurality of second connection portions are provided at the male connection member 120 to correspond to the first connection portions.

The matable connection portions 130 physically couple the female connection member 110 and the male connection member 120 in a matable manner, and electrically connects the plurality of first connection portions and the plurality of second connection portions. The plurality of matable connection portions 130 are provided to correspond to the number of first connection portions and second connection portions.

Each of the matable connection portions 130 includes an inner conductive material 140, a column 150, and elastic fins 160.

The inner conductive material 140 is provided on an inner wall of an insertion hole 113 formed in the female connection member 110. According to an examplary embodiment of the present invention insertion, the insertion hole 113 may have a shape resulting from recessing a surface (a lower surface in FIGS. 5 and 6) of the female connection member 110 to a predetermined depth, and may have a recessed shape in the shape of a cylinder. However, the insertion hole 113 may have this shape as well as having a through hole shape completely passing through the female connection member 110.

The inner conductive material 140 may have a shape stacked on the inner wall of the insertion hole 113 at a predetermined thickness, and may be formed using a plating process, coating process and the like. According to an examplary embodiment of the present invention, the inner conductive material 140 is formed along a perimeter (or circumference) of the inner wall of the insertion hole 113.

The inner conductive material 140 formed of a conductive material (for example, a metal) is electrically connected to the first connection portion, and as an example, the inner conductive material 140 in FIGS. 5 and 6 is connected to the pad 111 passing through the female connection member 110 through a bottom of the insertion hole 113

The column 150 has a conductive material and a structure protruding from the male connection member 120. The entire column 150 may have a conductive material, or an outside surface thereof may have a conductive material and an inside thereof may have an insulating material. As one example of the latter, the inside of the column 150 may be formed of a polymer, silicon, glass and the like, and only the outside surface thereof may be formed of the conductive material. As illustrated in FIG. 2, the column 150 is inserted into the insertion hole 113 of the female connection member 110 when the female connection member 110 faces the male connection member 120. The column 150 is electrically connected to the second connection portion of the male connection member 120, and in the examplary embodiment of the present invention, as an example, the column 150 is mounted on the pad 121 connected to a circuit pattern.

The inner conductive material 140 and the column 150 may be disposed in an array shape on the female connection member 110 and the male connection member 120. For example, it is possible for the inner conductive material 140 and the column 150 to be disposed in a matrix shape having a predetermined number of columns and rows, or other various shapes.

FIG. 7 is a plan view illustrating the column 150 and the elastic fins 160 illustrated in FIGS. 5 and 6.

The elastic fin 160 has a surface having a conductive material and configured to extend outside the column 150. The elastic fin 160 is configured to elastically contact the inner conductive material 140 by being elastically deformed when the column 150 is inserted into the insertion hole 113.

The elastic fins 160 may be bent in a direction opposite to an insertion direction of the column 150 when the column 150 is inserted into the insertion hole 113, and may have an integrated structure with the column 150 or have a configuration in which an additional layer is stacked on an upper surface of the column 150.

The elastic fin 160 may be formed of a conductive material capable of being elastically deformed (for example, a metal), or may be formed by a surface of an elastic material (for example, a polymer, a fiber) being coated with a conductive material (for example, a metal).

It is preferable to form the elastic fins 160 as a plurality so as to be in contact with a plurality of areas of the inner conductive material 140, and as illustrated in FIG. 7, the plurality of elastic fins 160 may be disposed along a circumferential direction of the column 150 to be spaced apart at a predetermined angle. Even though FIG. 7 illustrates a structure in which the four elastic fins 160 are disposed to be spaced apart at an angle of 90 degrees, it is possible to variously change the number and the shape of the elastic fins 160. For example, the elastic fins 160 may be formed as a plurality or one having a ring shape.

Hereinafter, an operation state of the matable electrical connection structure according to an examplary embodiment of the present invention will be described.

From a state in which the female connection member 110 and the male connection member 120 are separated from each other as illustrated in FIG. 5, the female connection member 110 and the male connection member 120 may be coupled by the column 150 of the male connection member 120 inserting into the insertion hole 113 of the female connection member 110 as illustrated in FIG. 6. In the process in which the column 150 is inserted into the insertion hole 113, the elastic deformation of the elastic fin 160 occurs by the elastic fin 160 being pressed by the inner conductive material 140 provided on the inner wall of the insertion hole 113, and thus, the elastic fin 160 is electrically in contact with the inner conductive material 140 due to a restoring force generated by elastic fin 160. The elastic restoring force acts as a coupling force between the female connection member 110 and the male connection member 120, and enables the female connection member 110 and the male connection member 120 not to become arbitrarily separated from each other.

Meanwhile, as the elastic fin 160 electrically connected to the second connection portion of the male connection member 120 is in contact with the inner conductive material 140 electrically connected to the first connection portion of the female connection member 110, it is possible to electrically connect the first connection portion and the second connection portion.

As described above, an additional physical coupling structure is not required due to implementing an electrical connection structure and a physical coupling structure together, and there is advantage in that a total thickness of the electrical connection structure is capable of being decreased by implementing the electrical connection structure in a horizontal contact structure at an inside of the female connection member 110. In addition, there are advantages in that an electrical signal speed may be increased by implementing the electrical connection structure in a low height and nearly linear structure, and a signal quality may be increased by reducing a signal loss.

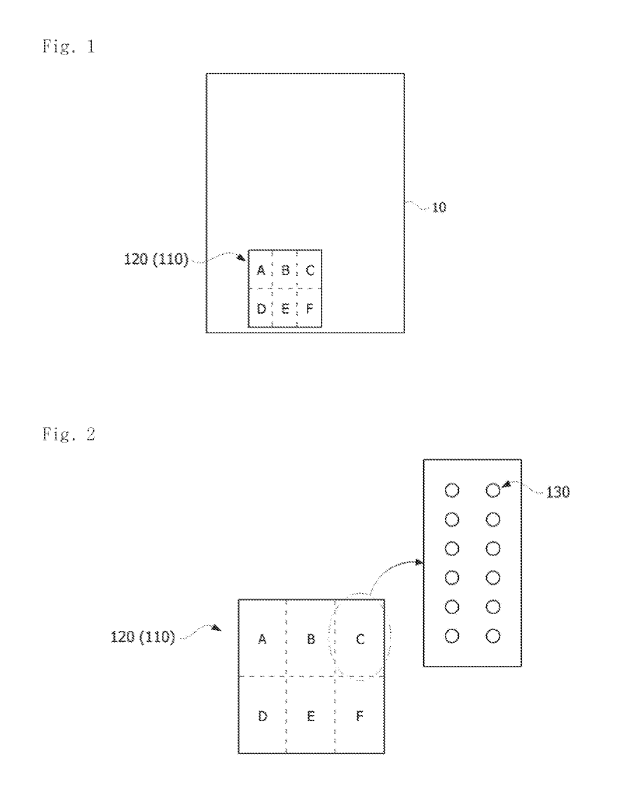

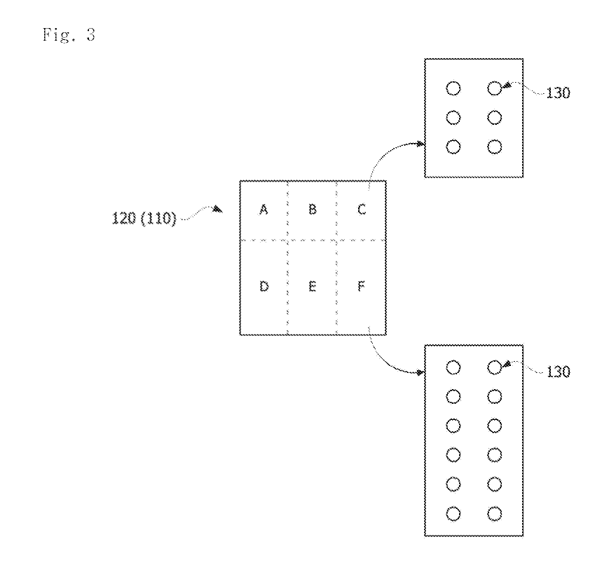

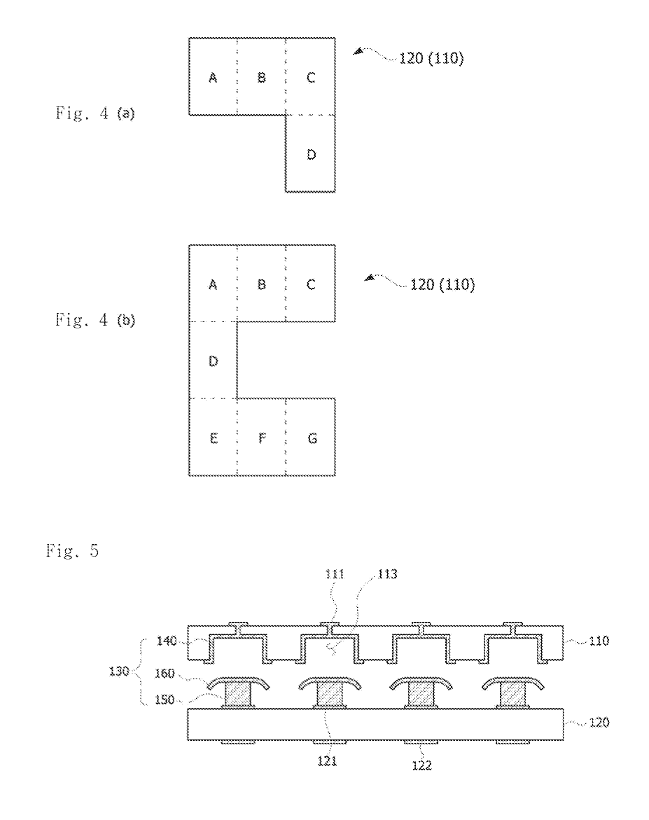

FIG. 1 is a plan view illustrating an examplary embodiment of a printed circuit board in which a matable electrical connection structure according to the present invention is applied, FIG. 2 is an enlarged view of the matable electrical connection structure in FIG. 1, FIG. 3 is a view illustrating a modification of the matable electrical connection structure in FIG. 2, and FIG. 4 is a schematic view illustrating an area arrangement shape of a matable electrical connection structure of the present invention.

According to the present invention, at least one of the female connection member 110 and the male connection member 120 is divided into a plurality of areas.

FIG. 1 shows an example in which the male connection member 120 of the matable electrical connection structure is mounted on the printed circuit board 10, and in the drawing, a structure in which the male connection member 120 is divided into six areas A to F is shown as an example. In FIG. 1, the dotted lines are virtual lines dividing the areas, and the dotted lines described below are the same.

When the male connection member 120 has a structure in which a single structure is divided into a plurality of areas, that is, the plurality of areas form an integrated single structure, the female connection member 110 connected to the structure thereof may also have a structure in which a single structure is divided into a plurality of areas.

Alternatively, it is possible that one of the female connection member 110 and the male connection member 120 has a structure in which a single structure is divided into a plurality of areas, and the other thereof has a plurality of structures in which each of the areas is divided or a part of the areas are divided.

A plurality of areas which divides the female connection member 110 or the male connection member 120 may be disposed adjacent to each other in an array shape. For example, the plurality of areas described above may be formed as a two dimensional array shape by the combination thereof. FIG. 1 shows an example in which a divided area shape has an array of a 3×2 matrix shape.

The arrangement shape of the areas is not limited thereto, and may be modified to various different shapes as illustrated in FIGS. 4(a) and (b).

In addition, even though each of a plurality of areas may have the same size as illustrated in FIG. 2, the plurality of areas may have different sizes as illustrated in FIG. 3.

Thus, there is an advantage in which a degree of freedom of design of the printed circuit board may be increased by implementing the electrical connection structure in a divided structure which has various arrangements, shapes, and sizes.

Thus, when at the least one of the female connection member 110 and the male connection member 120 has a structure divided into a plurality of areas, a plurality of matable connection portions 130 are disposed to form a group in each area. Here, the example of the structure of the matable connection portion 130 illustrated in FIGS. 5 to 7 is only one example of various embodiments of the present invention, the structure of the matable connection portion 130 applied thereto may be modified to various different shapes including the structure described above in addition to the exemplary shape illustrated in FIGS. 5 to 7.

That is, when the male connection member 120 has a structure divided into a plurality of areas, columns 150 are disposed as a plurality to form a group in each divided area. Then, when the female connection member 110 has a structure divided into a plurality of areas, the inner conductive material 140 of the insertion hole 113 is disposed as a plurality to form a group in each divided area.

The plurality of matable connection portions 130 may be disposed in an array shape in each area as illustrated in FIG. 2. FIG. 2 shows an example of a structure in which each of the matable connection portions 130 is disposed in a shape having two rows. In addition, a different number of the matable connection portions 130 may be disposed in each area as illustrated in FIG. 3.

Each area dividing the female connection member 110 or the male connection member 120 may be divided according to a type or function of component connected to the first connection portion or the second connection portion. For example, when the electrical connection structure is a connector mounted on the printed circuit board 10 installed in a mobile phone, terminals related to a camera module may be disposed in a specific area (for example, area A), and other terminals related to an illumination sensor may be disposed in another area (for example, area B).

Then, soldering areas of the first connection portion of the female connection member 110 or the second connection portion of the male connection member 120 are disposed in each divided area. For example, when the male connection member 120 is mounted on the printed circuit board 10 as illustrated in FIG. 1, each pad 122 of the lower surface of the male connection member 120 becomes a soldering area, and the pads 122 described above are disposed in each of the areas A to F.

According to the structure described above, there is an advantage in which securing of separation distances between the soldering portions is not required, because the structure is not a structure soldered at terminal fins extending outside thereof such as an electrical connection structure having a dual inline package (DIP) type but is a vertical soldering structure. In addition, as illustrated in FIG. 1, the electrical connection structure is not required to be divided and disposed on several areas of the printed circuit board 10, but the electrical connection structure may be separately disposed on a specific area of the printed circuit board 10 as illustrated in FIG. 1. Because of this structural feature, a mounting area occupied by the electrical connection structure may be decreased, many of the electrical connection structures may be disposed in a small space, and a freedom of circuit design and a space usage may be increased.

The matable electrical connection structure related to the present invention described above may be applied to various fields such as connectors for electrical connections, semiconductor package assemblies, interconnection structures for flip chips, mutual connection structures for capacitors of a multilayer ceramic capacitor (MLCC) and other components (or substrates), etc. Meanwhile, the matable electrical connection structure described above is not limited to the configurations and the methods of the embodiments described above, and various changes to the embodiments may be made by selectively combining all or a part of each of the embodiments, and the various changes may be made by those skilled in the art without departing from the spirit and scope of the present invention.

1. A matable electrical connection structure, comprising:
A female connection member and a male connection member respectively including a plurality of first connection portions and a plurality of second connection portions; and
a plurality of matable connection portions configured to detachably couple the female connection member and the male connection member, and respectively and electrically connect the plurality of first connection portions and the plurality of second connection portions,
wherein the matable connection portions include:
inner conductive materials respectively and electrically connected to the plurality of first connection portions and provided on inner walls of a plurality of insertion holes formed in the female connection member;
columns respectively and electrically connected to the plurality of second connection portions and configured to protrude from the male connection member to be inserted into the insertion hole; and
elastic fins configured to extend outside the column to elastically contact the inner conductive material, and
wherein at least one of the female connection member and the male connection member is divided into a plurality of areas, and the plurality of matable connection portions are disposed to form a group in each of the areas.

2. The structure of claim 1, wherein the elastic fins is bent in a direction opposite to an insertion direction of the column when the column is inserted.

3. The structure of claim 1, wherein the plurality of areas are divided according to a type or function of a component connected to the first connection portion or the second connection portion.

4. The structure of claim 1, wherein the plurality of areas in an array shape are disposed adjacent to each other.

5. The structure of claim 4, wherein the plurality of areas are combined with each other to form a two dimensional array shape.

6. The structure of claim 4, wherein each of the plurality of areas has the same size, or has a different size.

7. The structure of claim 1, wherein the plurality of matable connection portions are disposed in an array shape within each of the areas.

8. The structure of claim 1, wherein a soldering area of the first connection portion or the second connection portion and a printed circuit board is disposed in each of the areas.

9. The structure of claim 1, wherein the female connection member or the male connection member includes at least one of an active device, a passive device, a connector for electrical connection, a semiconductor chip package, an interposer applied to a semiconductor package, a semiconductor chip and package having a three dimensional multilayered structure, and a multilayered ceramic capacitor.

10. An electronic device comprising:
a housing configured to form an exterior of the electronic device; and
a matable electrical connection structure installed inside of the housing, and including claim 1.

11. An electronic device comprising:
a housing configured to form an exterior of the electronic device; and
a matable electrical connection structure installed inside of the housing, and including claim 2.

12. An electronic device comprising:
a housing configured to form an exterior of the electronic device; and
a matable electrical connection structure installed inside of the housing, and including claim 3.

13. An electronic device comprising:
a housing configured to form an exterior of the electronic device; and
a matable electrical connection structure installed inside of the housing, and including claim 4.

14. An electronic device comprising:
a housing configured to form an exterior of the electronic device; and
a matable electrical connection structure installed inside of the housing, and including claim 5.

15. An electronic device comprising:
a housing configured to form an exterior of the electronic device; and
a matable electrical connection structure installed inside of the housing, and including claim 6.

16. An electronic device comprising:
a housing configured to form an exterior of the electronic device; and
a matable electrical connection structure installed inside of the housing, and including claim 7.

17. An electronic device comprising:
a housing configured to form an exterior of the electronic device; and
a matable electrical connection structure installed inside of the housing, and including claim 8.

18. An electronic device comprising:
a housing configured to form an exterior of the electronic device; and
a matable electrical connection structure installed inside of the housing, and including claim 9.
